(19) United States
(12) Patent Application Publication
(10) Pub. No.: US 2014/0083763 A1
(43) Pub. Date: Mar. 27, 2014

(54) WIREjT

(71) Applicant: John Thomas Payne, III, Kill devil hills, NC (US)

(72) Inventor: John Thomas Payne, III, Kill devil hills, NC (US)

(73) Assignee: John Thomas Payne, III, Kill Devil Hills, NC (US)

(21) Appl. No.: 13/404,659

(22) Filed: Sep. 23, 2012

(51) Int. Cl. H01R 4/20

(52) U.S. Cl. CPC H01R 4/20
USPC 174/84 C

(57) ABSTRACT

WIRE jT is designed to facilitate efficient splicing of wires when installing after-market items into vehicles. Many consumers may add various features to their vehicles, such as lights, speaker systems, and other items that require re-wiring. WIRE jT provides mechanics with a way to easily and effectively splice wires. WIRE jT is principally used for wire splicing.

### BRIEF DESCRIPTION

WIRE jT is designed to facilitate efficient splicing of wires when installing after-market items into vehicles. Fully developed prototype available upon request.

### Purpose of the Invention

WIRE jT is designed to assist users in splicing wires when adding after-market items to existing vehicles. This innovative product features a set of tubes joined to create a “T” shape. An existing wire can be spliced at both ends. Each end can be placed through either side of the “T”, and the ends can be crimped down. The new wire may then be easily connected and secured to the crimped part of the existed wire. Using this product may allow individuals to add lights, speakers, and other similar items to vehicles in a fast, efficient, and professional manner.

### Problems Solved by the Invention

Many consumers may add various features to their vehicles, such as lights, speaker systems, and other items that require re-wiring. Traditional methods for installing these after-market items to existing vehicles may require installers to use several wires and to purchase electrical tape in order to fuse the existing wires with the new wires. This may not be effective fusing method, as the wires may easily come apart from each other. Alternatively, splicing the wires may not be an acceptable method for professional mechanics, and may be a time-intensive process. An effective and convenient solution is necessary.

### DETAILED DESCRIPTION

WIRE jT provides mechanics with a way to easily and effectively splice wires. The invention may comprise two pieces of copper tubes soldered together to form a “T”. Both sides of the wires may be crimped down to create one wire with a nipple. The secondary or new wire can then be placed through the center tube, and may be affixed to the nipple of the existing wires and crimped into place. This may create a secure and clean connection between the wires. The exact specifications may vary.

### How The Invention Works

If you need to add a wire to a hot wire you cut the hot wire insert each end of the hot wire into each end of the “T” and crimp it down you then add the new wire into the bottom of the “T” and crimp it down so that now all wires are hot and secure.

### What Makes the Invention Unique or Better than Other Products?

It makes a better connection, less risk of wires coming apart, and it looks more professional instead of having wires and tape all over. It can range in size from 10 gauge to 22 gauge.

### Specification

My specification has no new matter.

The WIRE jT is a simple make that takes copper tubing in a shape of a T put nicks about half way to each ends so it will make it easy to crimp and cover it in hard plastic.

### IMAGE INFO

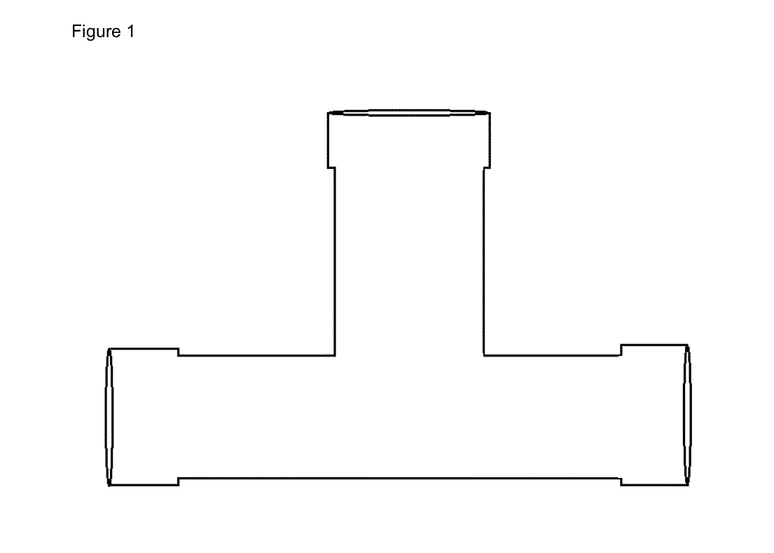

FIG. 1—Shows the sketch of the invention

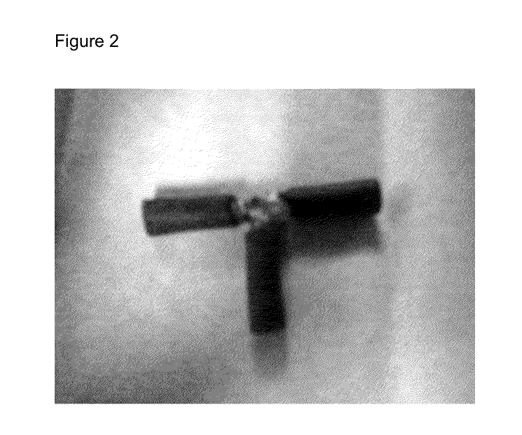

FIG. 2—Shows example of the prototype that's been made

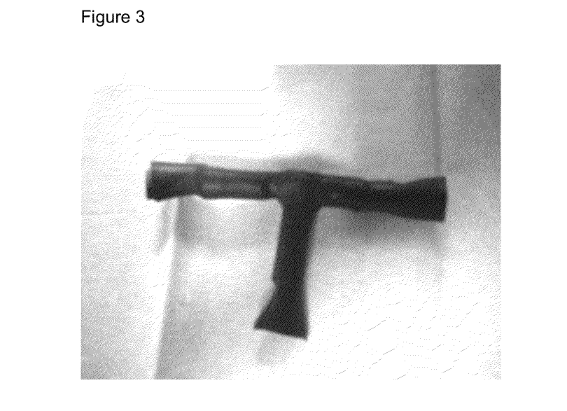

FIG. 3—Shows example of the prototype that's been made with shrink tape on it so it and be heated to be water proof

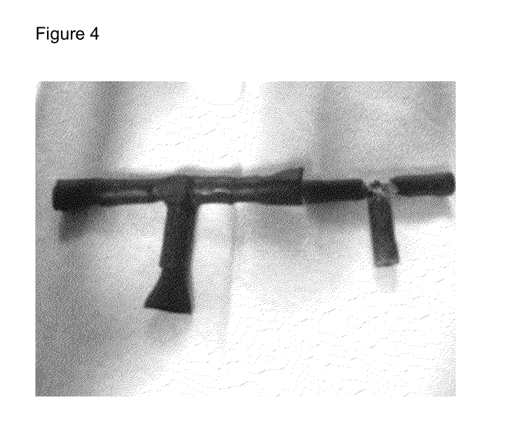

FIG. 4—Shows examples of the prototypes that's been made

1. Is a percentage of the whole sell and a lump sum to keep it with you

2. Or a large amount and take it all
